(19) United States
(12) Patent Application Publication
(10) Pub. No.: US 2015/0033631 A1
(43) Pub. Date: Feb. 5, 2015

(54) WOODWORK BEARING A STAINED GLASS WINDOW AND AN INSULATING GLAZING WITH AN AIR GAP BETWEEN THEM, ALLOWING THE AIR GAP TO COMMUNICATE WITH THE OUTSIDE FREE AIR

(71) Applicant: ASSELIN, Thouars (FR)

(72) Inventors: Patrick Asselin, Thouars (FR); Rene Bousseau, Thouars (FR); Thomas Gatineau, Thouars (FR); Boris Bachelier, Saint Generoux (FR)

(21) Appl. No.: 14/449,844

(22) Filed: Aug. 1, 2014

(30) Foreign Application Priority Data
Aug. 2, 2013 (FR) 1357692

(51) Int. Cl. E06B 3/34; E06B 5/20; E06B 7/16; E06B 7/02

(52) U.S. Cl. CPC E06B 3/34; E06B 7/02; E06B 5/205; E06B 7/16; E06B 2003/261
USPC 49/67

(57) ABSTRACT

A woodwork includes: a window frame, an outer frame bearing a stained glass window pivotable in relation to the window frame between closed and open positions, and an inner frame bearing an insulating glazing and pivotable in relation to the window frame. An air gap is arranged between the stained glass window and the insulating glazing. The outer frame is mounted mobile with pivoting in relation to the inner frame, with a peripheral seal constituting a sealing perimeter between the outer frame and the window frame. At least two air passages are arranged in the outer frame, one in a lower portion and the other in an upper portion of the outer frame, with each passage exiting in the air gap inside the sealing perimeter so as to place the air gap in communication with the outside free air.

### CROSS-REFERENCE TO RELATED APPLICATIONS

This Application claims priority to and benefits of French Patent Application No. FR 1357692, filed with the French Patent Office on Aug. 2, 2013, the content of which is incorporated herein by reference in its entirety.

### FIELD OF THE DISCLOSURE

The field of the invention is that of the design and manufacture of woodwork. More precisely, the invention relates to woodwork with a French-style opening intended for old, historical or prestigious buildings. The invention also relates to new constructions that are inspired by old woodwork but which are subjected to current thermal and acoustic requirements or in terms of burglar proofing.

### BACKGROUND OF THE DISCLOSURE

In the sector of old, historical or prestigious buildings, and in particular relating to religious edifices, it is common to arrange stained glass windows in the window openings.

In the framework of renovation work for these buildings, it is now becoming customary to seek to improve the characteristics of the building from a thermal and acoustical standpoint. Indeed, when these buildings are renovated, it is sought to meet the requirements of new standards, which entails achieving certain thermal or acoustical performance levels.

However, a difficulty then appears, being a question of retaining conventional aesthetics, while still achieving said thermal and acoustical performance levels.

In this context, it has been proposed to integrate double glazing in stained glass windows. However, these integrations have resulting in giving rise, in varying degrees, to the modern manufacturing techniques or mechanisms used, which more or less harm the traditional aesthetics required for certain creations.

Furthermore, these prior creations generally arrange an air gap between the stained glass window and the double glazing, with dirt and/or moisture able to be present in this air gap, which can result in the appearance of a deposit on the double glazing. Of course, if this occurs, this can mar in a more or less notable manner the visual perception of the stained glass window, when the latter is viewed from within the building.

### SUMMARY

An exemplary aspect of the present disclosure relates to a woodwork comprising:

a window frame;

an outer frame bearing a stained glass window able to pivot in relation to a window frame between a closed position and an open position;

an inner frame bearing an insulating glazing and able to pivot in relation to the window frame, an air gap being arranged between the stained glass window and the insulating glazing,

characterized in that the outer frame is mounted mobile with pivoting in relation to the inner frame, with a peripheral seal constituting a sealing perimeter between the outer frame and the window frame, with at least two air passages being arranged in the outer frame, one in the lower portion and the other in the upper portion of the outer frame, with each passage exiting in the air gap inside the sealing perimeter in such a way as to place in communication the air gap with the outside free air and communicating between them freely by the intermediary of the air gap.

In addition, the outer frame has an outer face extending from a peripheral edge having a thickness E, with the air passages existing into the thickness E of the outer frame.

As such, thanks to the invention, it is possible in particular to improve the thermal and acoustical performance of a French-style woodwork mounted on an old, historical or prestigious building, such as in particular certain churches or cathedrals, and this while still preserving the aesthetical qualities of the woodwork. Note that this remains also true for any brand new construction that is inspired from the old style with woodwork with stained glass windows.

Indeed, thanks to the circulation of air in the air gap present between the stained glass window and the insulating glazing, made possible by the presence of the passages in the outer frame, the risks of condensation on the insulating glazing are substantially limited, as well as the presence of dirt in the volume of the air gap, with both phenomena, individually or combined together, able to degrade over time the transparency of the insulating glazing and, consequently, the visual perception of the stained glass window through the insulating glazing.

That being so, even by substantially slowing down the damage to the transparency of the insulating glazing, it may be required to be able to clean, on the air gap side, the surface of the stained glass window and/or that of the insulating glazing. It is therefore provided, as shall be described in more detail in what follows, to allow easy and rapid access to these surfaces.

Moreover, as shall appear more clearly in what follows, a woodwork according to the invention can be proposed according to the traditional aesthetical criteria of the woodwork present on old, historical or prestigious buildings.

Note that, according to the principle of the invention, the air passages exit in the thickness of the outer frame, which avoids having to present the mouth of the air passages on the outer face of the outer frame, which would make them visible, with the risk of aesthetically affecting the woodwork.

On the contrary, the mouth of the air passages, as they are arranged in the thickness E of the outer frame, is entirely masked in the closed position of the outer frame, being turned towards the edge of the window frame.

Advantageously, the window frame has an outer edge that partially covers the outer face of the outer frame.

Such a characteristic is in line with the approach of preserving the traditional aesthetics of the woodwork according to the invention.

According to an advantageous solution, the air passages exit between the outer face and an inner edge of the outer frame, with the window frame having a peripheral bead in an intermediary position on which is mounted the peripheral seal, with the inner edge coming to press against the peripheral seal in the closed position of the outer frame.

According to another preferential solution, the inner frame is mounted pivotingly on an inner face of a post of the window frame, with the outer frame being mounted pivotingly on a post of the inner frame.

As such, it is possible to easily access the surfaces of the stained glass window and of the insulating glazing extending in the air gap, for example for the purposes of cleaning them (although this need is rather infrequent thanks to a woodwork according to the invention).

In this case, the outer frame and the inner frame each bear a metal frame, with the two metal frames being mounted articulated together.

Preferentially, the two metal frames are facing each other.

In this way, the articulation between the inner frame and the outer frame is allowed, and this with means that are entirely masked and invisible, regardless of the side from which the woodwork according to the invention is viewed.

Advantageously, the inner frame and the outer frame are both made from wood.

Once again, this characteristic contributes to maintaining the traditional aesthetic nature of the woodwork.

According to an alternative that can be considered, the inner frame bears a wooden section for shutting out the glazing.

### BRIEF DESCRIPTION OF THE DRAWINGS

Other characteristics and advantages of the invention shall appear more clearly when reading the following description of a preferred embodiment of the invention, provided as for the simple purposes of information and is not restricted, and of the annexed drawings among which:

FIGS. 1 and 2 are cross-section views, widthwise, of a woodwork according to the invention, respectively on its upper portion and its lower portion;

FIG. 3 is a cross-section view, in the direction of the height, of a woodwork according to the invention.

### DETAILED DESCRIPTION OF ILLUSTRATIVE EMBODIMENTS

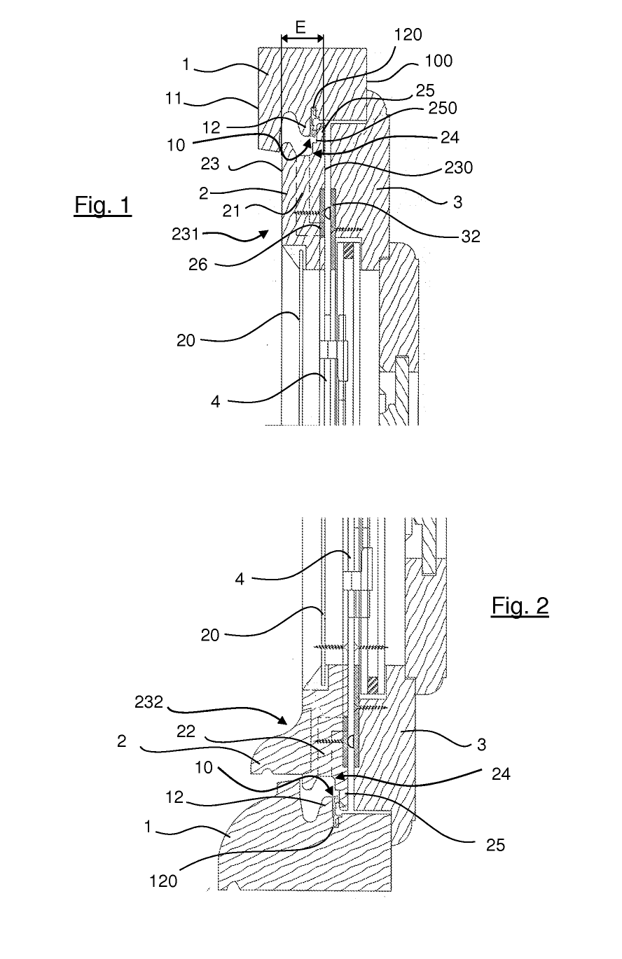

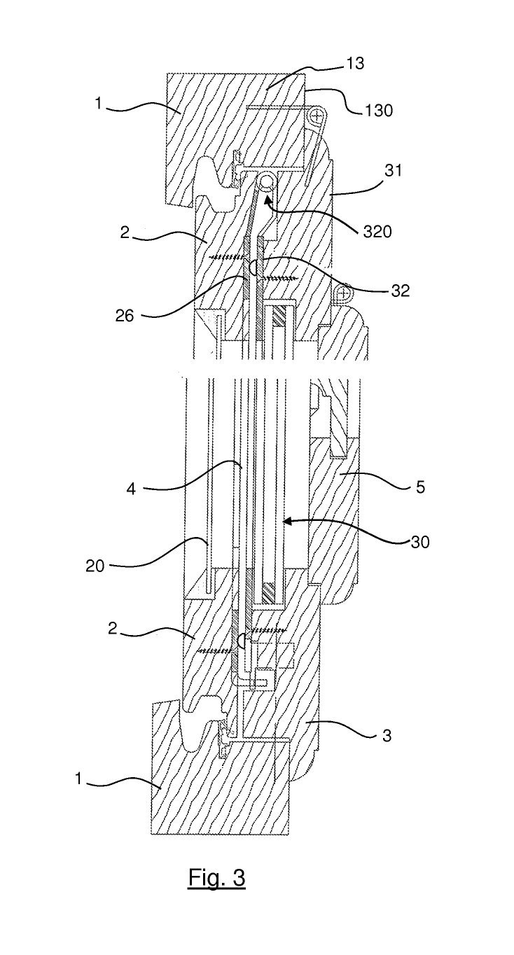

Such as shown in FIGS. 1 to 3, a woodwork according to the invention comprises:

a window frame 1, having an inner face 100 on the internal side of the building, and an outer face on the external side of the building, with the window frame having a square or rectangular shape comprising two side posts connected by an upper crosspiece and by a lower crosspiece;

an outer frame 2 bearing a stained glass window 20, having an outer face 23 on the external side of the building and an inner face 230 facing the inside of the building, the outer frame having a square or rectangular shape comprising two side posts connected by an upper crosspiece 231 and a lower crosspiece 232;

an inner frame 3 bearing an insulating glazing 30, with the inner frame 3 having a square or rectangular shape comprised of two side posts connected by an upper crosspiece and by a lower crosspiece.

According to a traditional method, the stained glass window is fastened onto the outer frame with flashing mastic.

Such as shall be explained in more detail in what follows, the woodwork is provided in such a way that:

the outer frame can pivot in relation to window frame 1 between a closed position and an open position;

the inner frame can pivot in relation to window frame 1;

an air gap 4 is arranged between the stained glass window 20 and the insulating glazing 30.

According to the principle of the invention, the outer frame 2 is mounted mobile with pivoting in relation to inner frame 3, and a peripheral seal 10 constitutes a sealing perimeter between the outer frame 2 and the window frame 1, with two air passages 21, 22 being arranged in the outer frame in such a way as to each exit into the air gap 4, and this inside the sealing perimeter delimited by the peripheral seal 10, in such a way as to place the air gap into communication with the outside free air A. The two air passages 21, 22 communicated freely between each other by the intermediary of the air gap 4.

Such as shown in FIGS. 1 and 2, the outer frame 2 has:

at least one air passage 21, in the upper portion of the woodwork, shown as a dotted line in FIG. 1, and more precisely in the upper crosspiece 231 of the outer frame;

an air passage 22, in the lower portion of the woodwork, shown in the form of a dotted line in FIG. 2, and more precisely extending through the lower crosspiece 232 of the outer frame.

More preferably, each crosspiece has at least two air passages.

In reference to FIGS. 1 and 2, the outer frame has a peripheral edge 24 extending from the outer face 23 to the inner face 230, and having a thickness E, with the air passages 21, 22 exiting in the thickness E of the outer frame.

According to this embodiment, each air passage as such extends from the peripheral edge, first of all vertically (with the woodwork itself considered as vertical) then has a right angle in order to then extend horizontally until it exits in the air gap.

Of course, the air can circulate between the window frame and the edge of the outer frame in order to reach the air passages.

Such as is shown in FIGS. 1 to 3, the air passages 21, 22 exit, on the peripheral edge side, in a gutter extending between the outer face of the outer frame, and an inner edge 25.

The window frame 1 has a peripheral bead 12 in an intermediary position on which is mounted the peripheral seal 10. To do this, the window frame 1 has a peripheral groove 120 wherein is embedded the peripheral seal 10. As such, the inner edge 25, by the intermediary of its face 250, comes to press against the peripheral seal 10 when the outer frame is in the closed position.

Moreover, the window frame 1 has an outer edge 11, on the external side of the building, partially covering the outer face 23 of the outer frame.

According to a preferred embodiment, the inner frame is mounted pivotingly on an inner face 130 of a post 13 of the window frame 1. Furthermore, the outer frame is itself mounted pivotingly on a post 31 of the inner frame 3.

As such, the inner frame is able to pivot in relation to window frame between a closed position and an open position, as well as the outer frame since it is borne by the inner frame.

Furthermore, it is possible to pivot the outer frame in relation to inner frame, in order to access the surface of the stained glass window and that of the insulating glazing extending in the air gap.

A locking system can be provided on the woodwork in such a way as to ensure the maintaining in closed position of the outer frame on the inner frame. The locking system can for example comprise a simple latch of which the position is changed in order to allow for the opening of the outer frame, i.e. its pivoting, in relation to the inner frame.

The pivoting mounting of the outer frame on the inner frame is carried out in the following manner:

the outer frame bears, on its face turned towards the air gap, a metal frame 26;

the inner frame bears, on its face turned towards the air gap, a metal frame 32 (the two metal frames 26, 32 are therefore facing each other);

the two metal frames 26, 32 are mounted articulated together.

Preferentially, the inner frame and the outer frame are both made of wood.

In this case, the metal frames 26, 32 are fastened on their respective frame by screwing.

According to an alternative that can be considered, the inner frame 3 bears a section 5 made of wood that can be brought into a position of shutting out the glazing. This section 5 is mounted pivotingly on the inner frame 3.

An exemplary aspect of the present disclosure provides a woodwork bearing a stained glass window on the external side and an insulating glazing on the internal side, which preserves the visual perception of the stained glass window viewed from within the building.

An exemplary aspect provides such a woodwork that complies with the traditional aesthetics of the woodwork generally present in old, historical or prestigious buildings.

Although the present disclosure has been described with reference to one or more examples, workers skilled in the art will recognize that changes may be made in form and detail without departing from the scope of the disclosure and/or the appended claims.

1. A woodwork comprising:
a window frame;
an outer frame bearing a stained glass window able to pivot in relation to the window frame between a closed position and an open position;
an inner frame bearing an insulating glazing and able to pivot in relation to window frame, with an air gap being arranged between the stained glass window and the insulating glazing, characterized in that wherein the outer frame is mounted mobile with pivoting in relation to the inner frame,
a peripheral seal constituting a sealing perimeter between the outer frame and the window frame, and
at least two air passages being arranged in the outer frame, one in the a lower portion and the other in the an upper portion of the outer frame, with each passage exiting in the air gap inside the sealing perimeter in such a way as to place the air gap in communication with the outside free air and communicating freely with each other by the intermediary of the air gap,
the outer frame having an outer face extending from a peripheral edge having a thickness, with the air passages exiting in the thickness of the outer frame.

2. The woodwork according to claim 1, wherein the window frame has an outer edge partially covering the outer face of the outer frame.

3. The woodwork according to claim 1, wherein the air passages exit between the outer face and an inner edge of the outer frame, with the window frame having a peripheral bead in an intermediary position whereon is mounted the peripheral seal, the inner edge coming to press against the peripheral seal in the closed position of the outer frame.

4. The woodwork according to claim 1, wherein the inner frame is mounted pivotingly on an inner face of a post of the window frame, with the outer frame being mounted pivotingly on a post of the inner frame.

5. The woodwork according to claim 4, wherein the outer frame and the inner frame each bear a metal frame, with the two metal frames being mounted articulated together.

6. The woodwork according to claim 5, wherein the two metal frames are facing each other.

7. The woodwork according to claim 1, wherein the inner frame and the outer frame are both made of wood.

8. The woodwork according to claim 1, wherein the inner frame bears a wooden section for shutting out the glazing.
